(19) United States
(12) Patent Application Publication
(10) Pub. No.: US 2012/0072869 A1
(43) Pub. Date: Mar. 22, 2012

(54) COPY SUPPORTING DEVICE, TERMINAL DEVICE, COPY SUPPORT METHOD, AND COPY SUPPORTING PROGRAM

(75) Inventors: Satoshi Odagawa, Ageo (JP); Kazushi Tahara, Saitama (JP)

(73) Assignee: PIONEER CORPORATION, Kanagawa (JP)

(21) Appl. No.: 13/322,744

(22) PCT Filed: Jun. 1, 2009
(86) PCT No.: PCT/JP2009/059963

§ 371 Date: Nov. 28, 2011

(51) Int. Cl. G06F 3/048

(52) U.S. Cl. 715/810

(57) ABSTRACT

A copy supporting device includes a receiving unit, a content list display unit, a first input accepting unit, a sub menu display unit, a second input accepting unit, and a relevant content extracting unit. The sub menu display unit displays, on the basis of attribute information of the designated content which is designated from the content list by the external input, a sub menu which includes items designating relevance to the designated content. The second input accepting unit accepts a designation of an item in the sub menu by the external input. The relevant content extracting unit extracts contents related to the designated content from the content list on the basis of the designated item.

### TECHNICAL FIELD

The present invention relates to a technology for making a selection of data to be copied easy.

### BACKGROUND TECHNIQUE

Conventionally, there are known methods of copying contents, such as images, stored in each device between different devices. For example, in Patent Reference-1, there is disclosed an information processing device which realizes transfers and copies of images between different devices by easy operation. Additionally, there are disclosed techniques related to the present invention in Patent References-2 to -4.
Patent Reference-1: Japanese Patent Application Laid-open under No. 2001-156983
Patent Reference-2: Japanese Patent Application Laid-open under No. 2005-032021
Patent Reference-3: Japanese Patent Application Laid-open under No. 2001-156983
Patent Reference-4: Japanese Patent Application Laid-open under No. 2001-156983

### DISCLOSURE OF INVENTION

### Problem to be Solved by the Invention

Generally, when a content such as a photograph or a moving picture is copied from other device, there is a case where not only one content but also a number of relevant contents are desired to be copied at once according to a predetermined aspect. At this time, in order to simplify the copy operation, it is needed to present a user with relevant contents according to relevance which the user intends. In Patent Reference-1 to -4, the above problem is not considered at all.

The present invention has been achieved to solve the above problem. It is an object of this invention to provide a copy supporting device capable of making the copy operation of contents easy by using attribute information of the contents.

### Means for Solving the Problem

In the invention according to claim 1, there is provided a copy supporting device which communicates with a first terminal used by a user who provides contents, including a receiving unit which receives a content list of the contents which the user possesses from the first terminal, a content list display unit which displays the content list, a first input accepting unit which accepts an external input for designating any content in the content list, and a sub menu display unit which displays, on the basis of attribute information of a designated content which is designated from the content list by the external input, a sub menu which includes items designating relevance to the designated content, a second input accepting unit which accepts a designation of the item by an external input, and a relevant content extracting unit which extracts contents related to the designated content from the content list on the basis of the designated item.

In the invention according to claim 6, there is provided a terminal device which sends a recording instruction signal to a program recording device which records designated programs, including a program information obtaining unit which obtains program information including identification names of programs and attribute information of the programs by an electromagnetic method, and a program list display unit which displays a list of programs based on the program information, and a first input accepting unit which accepts an external input for designating any program in the list, and a sub menu display unit which displays a sub menu including items which designates relevance to the designated program on the basis of the attribute information of the designated program which is designated from the list by the external input, and a second input accepting unit which accepts a designation of the item by an external input, and a relevant program extracting unit which extracts programs related to the designated program from the list on the basis of the designated item.

In the invention according to claim 8, there is provided a copy supporting method which is executed by a copy supporting device which communicates with a first terminal used by a user who provides contents, including a receiving process which receives a content list of the contents which the user possesses from the first terminal, a content list display process which displays the content list, a first input accepting process which accepts external input for specifying any content in the content list, a sub menu display process which displays, on the basis of attribute information of a designated content which is designated from the content list by the external input, a sub menu which includes items designating relevance to the designated content, a second input accepting process which accepts a designation of the item by an external input, and a relevant content extracting process which extracts contents related to the designated content from the content list on the basis of the designated item.

In the invention according to claim 9, there is provided a copy supporting program which is executed by a computer which communicates with a first terminal used by a user who provides contents, making the computer function as a receiving unit which receives a content list of the contents which the user possesses from the first terminal, a content list display unit which displays the content list, a first input accepting unit which accepts an external input for designating any content in the content list, a sub menu display unit which displays, on the basis of attribute information of the designated content which is designated from the content list by the external input, a sub menu which includes items designating relevance to the designated content, a second input accepting unit which accepts a designation of the item by external input, a relevant content extracting unit which extracts contents related to the designated content from the content list on the basis of the designated item.

### BRIEF DESCRIPTION OF THE DRAWINGS

FIG. 1 shows one example of a schematic configuration of a content copy system in the first embodiment;

FIG. 2 shows one example of a schematic configuration of the navigation device;

FIGS. 3A and 3B show examples of a schematic configuration of the first terminal and the second terminal;

FIGS. 4A to 4C show one example of a screen image which the navigation device outputs at the time when the user selects a content from a content list in the first example, and examples of a sub menu displayed at the same time;

FIG. 5 shows one example of a screen image of the navigation device when a selection item Si is designated;

FIGS. 6A to 6C show one example of a screen image which the navigation device outputs at the time when the user selects the content from the content list in the second example, and examples of the sub menu displayed at the same time;

FIG. 7 shows one example of a sequence diagram for executing the copy of a designated content;

FIG. 8 shows one example of a flow chart which shows the procedure of the process in the first embodiment;

FIG. 9 shows one example of a schematic configuration of the content copy system in the first modification;

FIGS. 10A and 10B show examples of configurations of a program reservation system in the second embodiment; and

FIGS. 11A and 11B show examples of screen images which the third terminal outputs in the second embodiment.

### DETAILED DESCRIPTION OF THE PREFERRED EMBODIMENTS

According to one aspect of the present invention, there is provided a copy supporting device which communicates with a first terminal used by a user who provides contents, including: a receiving unit which receives a content list of the contents which the user possesses from the first terminal a content list display unit which displays the content list; a first input accepting unit which accepts an external input for designating any content in the content list; a sub menu display unit which displays, on the basis of attribute information of the designated content which is designated from the content list by the external input; a sub menu which includes items designating relevance to the designated content; a second input accepting unit which accepts a designation of the item by an external input; and a relevant content extracting unit which extracts contents related to the designated content from the content list on the basis of the designated item.

The above copy supporting device is a navigation device for example, and includes a receiving unit, a content list display unit, a first input accepting unit, a sub menu display unit, a second input accepting unit, and a relevant content extracting unit. The receiving unit receives the content list which includes identification names of the contents from the first terminal. The content list display unit displays the content list. The first input accepting unit accepts an external input for designating any content in the content list by touch panels or others. The term “external input” herein indicates the input based on the user operation. The sub menu display unit displays, on the basis of attribute information of the designated content which is designated from the content list by the external input, a sub menu which includes items designating relevance to the designated content. The term “attribute information” herein includes not only attribute which the content originally has, such as the title and the recording time, but also attribute which is generated due to the user action, such as the day of the reproduction and the place of the reproduction. The attribute information may be information which is generated by the first terminal or the copy supporting device on the basis of the user input or information which the first terminal or the copy supporting device generates by analyzing the content at the time of the reproduction. The second input accepting unit accepts a designation of an item in the sub menu by the external input. The relevant content extracting unit extracts contents related to the designated content from the content list on the basis of the designated item. Namely, the relevant content extracting unit extracts contents which have relevance to the designated content in terms of the designated item from the content list. The term “extract” does not necessarily means to extract data itself of the contents but indicates a process to designate and select the identification names of the contents from the content list. After then, the copy supporting device may copy the extracted contents or may additionally let the user designate contents to be copied from the extracted contents. In this way, by displaying the sub menu and letting the user designate the item, the copy supporting device can properly extract relevant contents on the basis of relevance which the user designates. Thus, it becomes possible to make the copy operation by the user easy and improve the usability.

In a manner of the above copy supporting device, the copy supporting device further includes a relevant content list display unit which displays a relevant content list which is a list of contents extracted by the relevant content extracting unit, and a copy control executing unit which executes a control of copying a content which is designated from the relevant content list on the basis of the external input. Thereby, the copy supporting device can make the copy operation by the user easy and promptly execute the copy of contents according to intention of the user.

In another manner of the above copy supporting device, the copy supporting device communicates with a second terminal used by a user who is provided with the content, the receiving unit receives a content list of the second terminal, the content list display unit displays the content list of the second terminal, and the copy control executing unit executes the control of copying a content which is transferred from the relevant content list to the content list of the second terminal on the basis of the external input. Thereby, the copy supporting device can easily realize the transfer of the copied contents between the user of the first terminal and the user of the second terminal.

In another manner of the above copy supporting device, the attribute information includes a first attribute which the content originally has and a second attribute which is generated due to a user action. For example, in case of music, the first attribute corresponds to the title of an album where the content is recorded, the artists to perform, the genre, and the melody. In case of photograph which is taken personally, the first attribute corresponds to the subject person and the shooter. For example, the second attribute corresponds to a day of the reproduction which is designated due to a user action, a place of the reproduction, and a driving route at the time of the reproduction. This kind of attribute information may be, for example, information which is adjunct to the content integrally, information which is detected and/or analyzed by the copy supporting device, the first terminal, and/or the second terminal as described above, or information which is manually inputted by the user. In this way, by using the first information and/or the second information, the copy supporting device can extract relevant contents more conforming to the intention of the user.

In another manner of the above copy supporting device, the sub menu display unit displays the sub menu including items each of which indicates commonality between the user of the first terminal and the user of the second terminal on the basis of the attribute information of the designated content. The term “items each of which indicates commonality” herein indicates items which designate predetermined commonality such as “common favorite artist”, “common favorite genre”, and “content in which we are taken together”. Thereby, the copy supporting device can extract contents which the user intends more flexibly, and improve the usability.

It is noted that, in the above example, the contents is not necessarily stored in the first terminal and/or the second terminal, and may be contents which can be accessed by the first terminal and/or the second terminal. Concretely, the contents may be stored in a storage device such as a server connected to a network which the first terminal and the second terminal can access as well.

According to another aspect of the present invention, there is provided a terminal device which sends a recording instruction signal to a program recording device which records designated programs, including: a program information obtaining unit which obtains program information which contains identification names of programs and attribute information of the programs by an electromagnetic method; a program list display unit which displays a list of programs based on the program information; a first input accepting unit which accepts an external input for designating any program in the list; a sub menu display unit which displays a sub menu including items which designates relevance to the designated program on the basis of the attribute information of the designated program which is designated from the list by the external input; a second input accepting unit which accepts a designation of the item by an external input; and a relevant program extracting unit which extracts programs related to the designated program from the list on the basis of the designated item.

The above terminal device is a terminal device which sends a recording instruction signal to a program recording device which records designated programs and which includes a program information obtaining unit, a program list display unit, a first input accepting unit, a sub menu display unit, a second input accepting unit, and a relevant program extracting unit. The program information obtaining unit obtains program information which includes identification names of programs and attribute information of the programs by an electromagnetic method such as a broadcast and the Internet. The program list display unit displays a list of programs, i.e., a program list, based on the program information. The first input accepting unit accepts the external input for designating any program in the list. The sub menu display unit displays a sub menu including items which designates relevance to the designated program on the basis of the attribute information of the designated program designated from the list by the external input. Here, the attribute information corresponds to adjunct information such as the genre of the program and the performer in the program, for example. It is noted that the attribute information may include not only the program information obtained by the program information obtaining unit but also the result which the terminal device automatically retrieves by the Internet. The second input accepting unit accepts a designation of an item in the sub menu by the external input. The relevant program extracting unit extracts the programs related to the designated program from the list on the basis of the designated item. After that, the terminal device sends a program recording device a recording instruction signal of all of the extracted programs or the following extracted programs if the user further extracts program. Thereby, the terminal device can extract relevant programs which the user intends and make the reservation operation of programs easy.

In one manner of the above terminal device, the terminal further includes a relevant program list display unit which displays a relevant program list which is a list of the programs extracted by the relevant program extracting unit, and a program reservation notifying unit which sends the recording instruction signal of the program which designated from the relevant program list on the basis of an external input. As described above, by presenting a program list which the user intended and letting the user select, the terminal device can let the user easily and precisely execute the operation of the program reservation.

According to another aspect of the present invention, there is provided a copy supporting method executed by a copy supporting device which communicates with a first terminal used by a user who provides contents, including: a receiving process which receives a content list of the contents which the user possesses from the first terminal; a content list display process which displays the content list; a first input accepting process which accepts an external input for designating any content in the content list; a sub menu display process which displays, on the basis of attribute information of the designated content designated from the content list by the external input; a sub menu which includes items designating relevance to the designated content; a second input accepting process which accepts a designation of the item by an external input; and a relevant content extracting process which extracts contents related to the designated content from the content list on the basis of the designated item. By using the above method, the copy supporting device can extract relevant contents which the user intends and make the copy operation easy.

According to another aspect of the present invention, there is provided a copy supporting program which is executed by a computer which communicates with a first terminal used by a user who provides contents, making the computer function as: a receiving unit which receives a content list of the contents which the user possesses from the first terminal; a content list display unit which displays the content list; a first input accepting unit which accepts an external input for designating any content in the content list; a sub menu display unit which displays, on the basis of attribute information of the designated content designated from the content list by the external input; a sub menu which includes items designating relevance to the designated content; a second input accepting unit which accepts a designation of the item by an external input; and a relevant content extracting unit which extracts contents related to the designated content from the content list on the basis of the designated item. By the above program installed on a copy supporting device, the copy supporting device can extract relevant contents which the user intends and make the copy operation easy. In a preferred example, the above program is stored in a recording medium.

### EMBODIMENTS

Preferred embodiments of the present invention will be explained hereinafter with reference to the drawings.

### First Embodiment

A description will be given of a content copy system in the first embodiment of the present invention. In the following, a configuration of the system in the first embodiment will be described first, and then descriptions will be given of configurations of a navigation device and a first and a second terminals which are the components of the system, a supporting method of selection of contents, an example of transmission of copied content, and process flow in turn. Then, a description will be given of each modification in the first embodiment.

The term “content” herein includes movie, music, drama, generative writing, photograph, cartoon, animation, and computer game. The content also includes other characters, graphic, color, sound, motion, image, and any combination of them, and program to provide information of them by using a computer.

(Schematic Configuration of System)

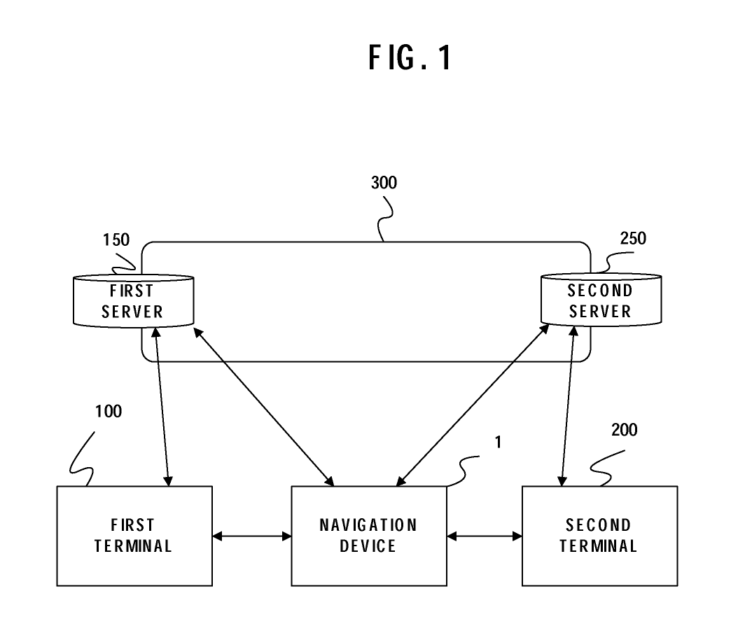

FIG. 1 shows an example of a schematic configuration of a content copy system in the first embodiment. The content copy system includes a navigation device 1, a first terminal 100, a first server 150, a second terminal 200, a second server 250, and a communication network 300.

The navigation device 1 is mounted on a moving body such as a vehicle, and displays a map on the screen for driver, and guides a route to a destination by using an autonomous navigation device such as a Global Positioning System (GPS), a vehicle speed pulse, and a gyroscope at the time when the moving body is running.

Besides, the navigation device 1 communicates with the first terminal 100 and the second terminal 200 wirelessly at close range. Concretely, the navigation device 1 receives a content list (hereinafter referred to as “content list CL1”) which the first terminal 100 has, and also receives a content list (hereinafter referred to as “content list CL2”) which the second terminal 200 has. In addition, the navigation device 1 receives attribute information (hereinafter referred to as “attribute information Is”) of each content which constitutes the content lists CL1 and CL2 from the first terminal 100 and the second terminal 200 respectively. The attribute information Is, as described below, is classified into an attribute (hereinafter referred to as “first attribute Is1”), such as the category of the content and the performers, which the content originally has, and an attribute (hereinafter referred to as “second attribute Is2”), such as a day of the reproduction and a place of the reproduction, which is generated due to user action. It is noted that the navigation device 1 may generate the attribute information Is by itself as described below.

Also, the navigation device 1 accesses the communication network 300 by wireless and communicates with the first server 150 and the second server 250 connected to the communication network 300. Concretely, the navigation device 1 reproduces a content which the first server 150 or the second server 250 has by downloading or streaming. Further, the navigation device 1 executes the control of providing the second server 250 with a copy of a content which the first server 150 has and also executes the control of providing the first server 150 with a copy of a content which the second server 250 has on the basis of operation by the user (hereinafter referred to as “user A”) of the first terminal 100 and the user (hereinafter referred to as “user B”) of the second terminal 200. The communication network 300 is, for example, a communication network including a public network such as the Internet and a closed network.

The first terminal 100 is configured to be able to communicate with the navigation device 1 and has the content list CL1 of contents which the first server 150 stores and the attribute information Is corresponding to the content list CL1. The content list CL1 is, for example, a list of contents, for which the user A of the first terminal 100 has the right to transfer its copy to anyone else, in the contents which the first server 150 stores.

The first server 150 is configured to be able to communicate with other devices through the communication network 300 and stores contents corresponding to the content list CL1. The first server 150 provides the contents to the second server 250 based on the control of the navigation device 1.

The second terminal 200 is configured to be able to communicate with the navigation device 1, and has the content list CL2 of the contents stored in the second server 250 and the attribute information Is corresponding to the content list CL2. The content list CL2 is, for example, a list of contents, for which the user B of the second terminal 200 has the right to transfer its copy to anyone else, in the contents which the second server 250 stores.

The second server 250 is configured to be able to communicate with other devices through the communication network 300 and stores contents corresponding to the content list CL2. The second server 250 provides the contents to the first server 150 based on the control of the navigation device 1.

(Schematic Configuration of Navigation Device)

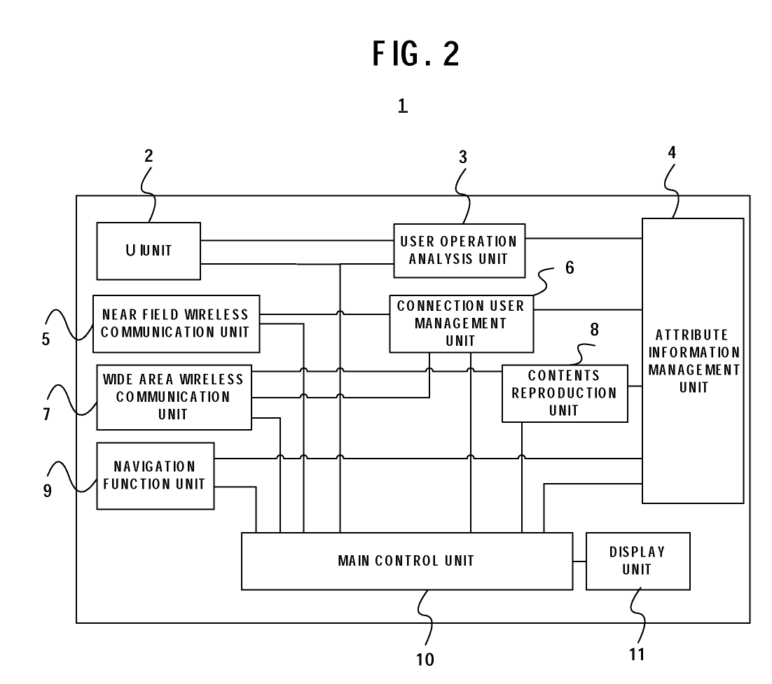

Next, a configuration of the navigation device 1 will be described with reference to FIG. 2.

FIG. 2 is one example of a schematic configuration of the navigation device 1. The navigation device 1 includes a UI (User Interface) unit 2, a user operation analysis unit 3, an attribute information management unit 4, a near field wireless communication unit 5, a connection user management unit 6, a wide area wireless communication unit 7, a contents reproduction unit 8, a navigation function unit 9, a main control unit 10, and a display unit 11.

The UI unit 2 is an interface which accepts inputs by the user A, the user B, and other crew (simply referred to as “user”) in the moving body on which the navigation device 1 is mounted. The UI unit 2 may be a touch panel which accepts input by the finger, a remote controller, a button, and a microphone which accepts voice input, for example. Especially, in the present invention, the user enters a predetermined input through the UI unit 2 when the user wants to intentionally add the attribute information Is to a content as necessary.

The user operation analysis unit 3 analyzes the information which has been inputted through the UI unit 2. Then, the user operation analysis unit 3 provides the analysis result to the attribute information management unit 4.

The attribute information management unit 4 manages the attribute information Is. Concretely, the attribute information management unit 4 generates and stores the attribute information Is based on information which is provided by the user operation analysis unit 3, the connection user management unit 6, the contents reproduction unit 8, and the navigation function unit 9. At this time, the attribute information Is is stored in association with the identification information of the corresponding content or the link information for accessing the content.

The near field wireless communication unit 5 communicates wirelessly with the first terminal 100 and the second terminal 200 at close range according to a predetermined communication method. The above communication method is, for example, Bluetooth (registered trademark). The wide area wireless communication unit 7 accesses the communication network 300 by wireless and communicates with devices (terminals) connected to the communication network 300.

The connection user management unit 6 identifies a terminal which is communicating by the near field wireless communication unit 5 and controls its user information. Concretely, by identifying the terminal and its user which is communicating wirelessly at close range, the connection user management unit 6 identifies, for example, who watches the content under reproduction, and provides the information thereof to the attribute information management unit 4. Similarly, the connection user management unit 6 provides the attribute information management unit 4 with the user information of other terminal which is communicating by the wide area wireless communication unit 7 or the owner information of the content being transmitted.

The contents reproduction unit 8 decodes and reproduces the contents provided by the wide area wireless communication unit 7. The reproduced content is outputted by the display unit 11 and/or a speaker not shown. The contents reproduction unit 8 provides the attribute information unit 4 with information concerning the content under reproduction and information concerning the reproduction time. Also, for example, in a case where the content provided by the wide area wireless communication unit 7 is a music content, the contents reproduction unit 8 analyzes the melody of the content (whether it is cheerful melody or not) and provides the analysis result to the attribute information management unit 4.

By using an autonomous navigation device such as GPS, a vehicle speed pulse and a gyroscope, the navigation function unit 9 guides a route to a destination on the display unit 11 for the driver at the time when the moving body is running. Then, the navigation function unit 9 provides the attribute information management unit 4 with information concerning the current position of the moving body and the driving route. For example, at the time of reproducing the content, the attribute information management unit 4 associates the provided information including the current position and the driving route with the identification name of the content, and manages it as the attribute information Is.

The main control unit 10 includes a CPU (Central Processing Unit), a ROM (Read Only Memory), and a RAM (Random Access Memory) which are not shown, and executes various kinds of controls of each component in the navigation device 1.

The display unit 11 is a display (monitor) which displays route information of the moving body and an image of a content.

(Schematic Configuration of First Terminal and Second Terminal)

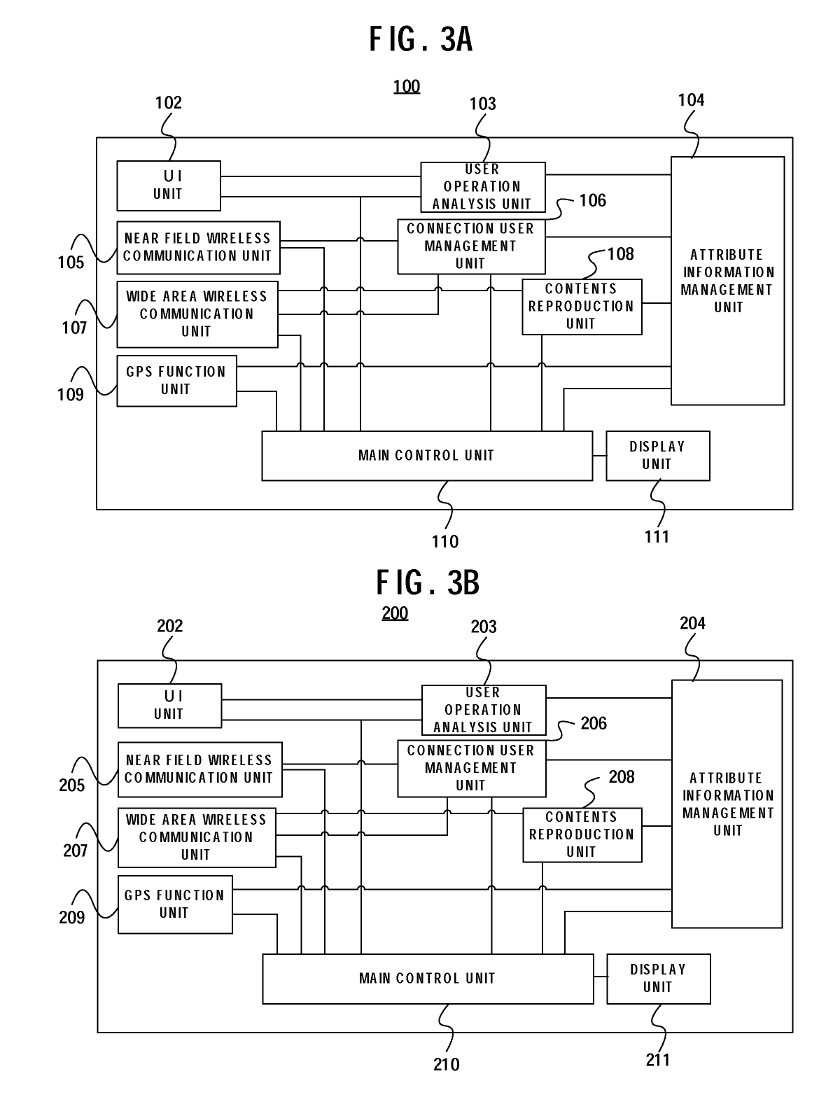

Next, a description will be given of configurations of the first terminal 100 and the second terminal 200 with reference to FIGS. 3A and 3B. FIG. 3A shows a schematic configuration of the first terminal 100 and FIG. 3B shows a schematic configuration of the second terminal 200. The first terminal 100 includes a UI unit 102, a user operation analysis unit 103, an attribute information management unit 104, a near field wireless communication unit 105, a connection user management unit 106, a wide area wireless communication unit 107, a contents reproduction unit 108, a GPS function unit 109, a main control unit 110, and a display unit 111. The second terminal 200 includes a UI unit 202, a user operation analysis unit 203, an attribute information management unit 204, a near field wireless communication unit 205, a connection user management unit 206, a wide area wireless communication unit 207, a contents reproduction unit 208, a GPS function unit 209, a main control unit 210, and a display unit 211. Since the components of the first terminal 100 coincide with the components of the second terminal 200, each component of both configurations will be explained in parallel below.

The UI units 102 and 202 are interfaces which accept input by the users. The UI units 102 and 202 are, for example, touch panels which accept input by the fingers, remote controllers, buttons, and microphones which accept voice input. Especially, in the present invention, the users enter predetermined input by the UI units 102 and 202 when the users want to intentionally add the attribute information Is to a content in the content lists CL1 and CL2 as necessary.

The user operation analysis units 103 and 203 analyze the information which is input by the UI units 102 and 202, respectively. Then, the user operation analysis units 103 and 203 provide the analysis result to the attribute information management units 104 and 204, respectively.

The attribute information management units 104 and 204 manage the attribute information Is. Concretely, the attribute information management units 104 and 204 generate and store the attribute information Is based on the information provided by the user operation analysis units 103 and 203, the connection user management units 106 and 206, the contents reproduction units 108 and 208, and the GPS function units 109 and 209. At that time, the attribute information Is is stored to be associated with identification information of the corresponding content or link information for accessing the content.

The near field wireless communication units 105 and 205 communicates wirelessly with the navigation device 1 at close range according to predetermined communication method, respectively. The above communication method is, for example, Bluetooth (registered trademark). The wide area wireless communication units 107 and 207 access the communication network 300 by wireless and communicate with devices (terminals) connected to the communication network 300.

The connection user management units 106 and 206 identify terminals which are communicating by the near field wireless communication units 105 and 205, respectively, and manage the user information. Concretely, by identifying the terminals and their users which are communicating wirelessly at close range, the connection user management units 106 and 206 identify, for example, who watches the content under reproduction, and provide the information thereof to the attribute information management units 104 and 204, respectively. Similarly, the connection user management units 106 and 206 provide the attribute information management units 104 and 204 with the user information of other terminals which are communicating by the wide area wireless communication units 105 and 205 or the owner information of the contents being transmitted, respectively.

The contents reproduction units 108 and 208 decode and reproduce the contents provided by the wide area wireless communication units 107 and 207, respectively. The reproduced contents are outputted by the display units 111 and 211, and/or, speakers not shown, respectively. The contents reproduction units 108 and 208 provide the attribute information units 104 and 204 with information concerning the contents being reproduced and information concerning the reproduction time, respectively. Also, for example, in a case where each of the contents provided by the wide area wireless communication units 107 and 207 is a music content, the contents reproduction units 108 and 208 analyze the melody of the contents (whether it is cheerful melody or not) and provide the analysis result to the attribute information management units 104 and 204, respectively.

Each of the GPS function units 109 and 209 includes a GPS, and specifies the current position of the first terminal 100 or the second terminal 200. Then, the GPS function units 109 and 209 provide information of the specified current positions to the attribute information management units 104 and 204, respectively.

Each of the main control units 110 and 210 includes a CPU (Central Processing Unit), a ROM (Read Only Memory), and a RAM (Random Access Memory), and executes various kinds of controls for each component in the first terminal 100 or the second terminal 200.

The display units 111 and 211 display images or pictures which are outputted by the first terminal 100 and the second terminal 200, respectively.

(Supporting Method of Content Selection)

Next, a concrete description will be given of a supporting method of selecting contents in the first embodiment of the present invention. The first embodiment illustrates a process for assigning copies of the contents from the user A to the user B by letting the user (mainly the user B) select any content from the content list CL1 which is displayed on the display unit 11 of the navigation device 1.

In summary, at first, the navigation device 1 displays a list (hereinafter referred to as “sub menu SL”) including items each of which designates relevance to a content (hereinafter referred to as “content As”) which the user selects from the content list CL1. Then, the navigation device 1 extracts contents, which are related to an item (hereinafter referred to as “selection item Si”) which the user selects from the sub menu SL, from the content list CL1 and presents them to the user. Thereby, the navigation device 1 makes the copy operation of contents easy.

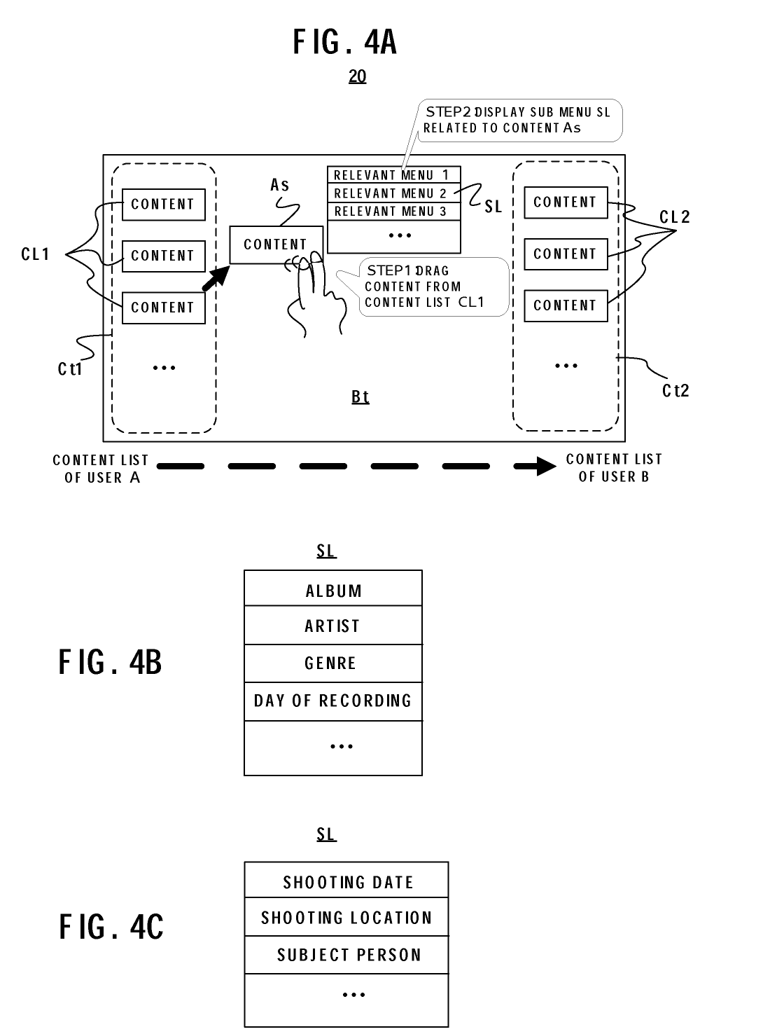

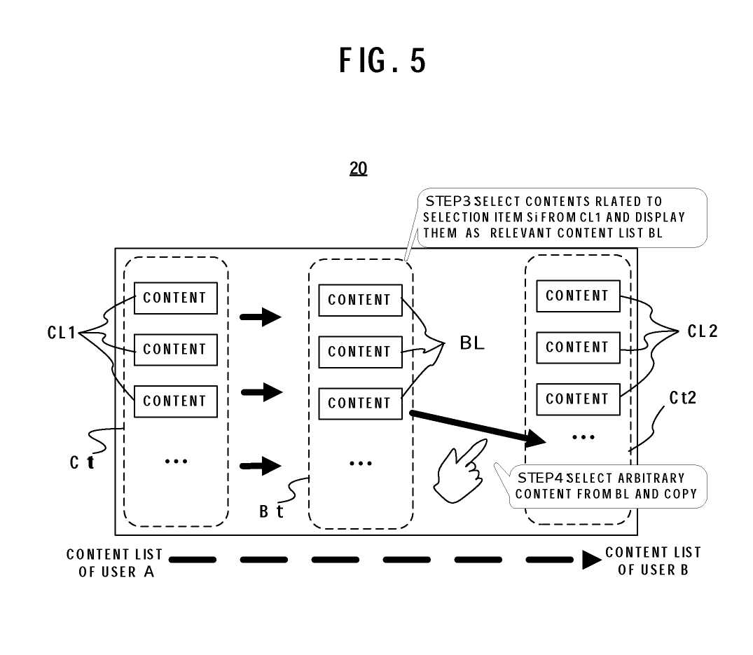

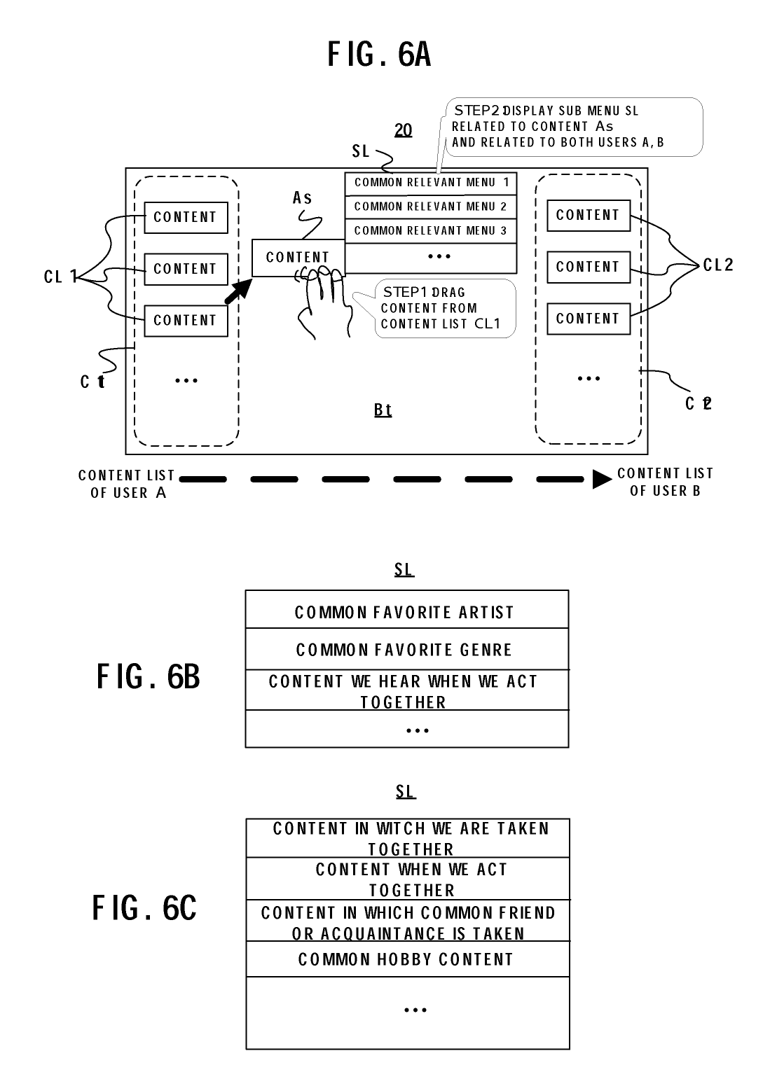

This will be concretely described below by using examples of screen images which are outputted by the display unit 11 of the navigation device 1. In the following, a description of a first example will be given with reference to FIG. 4 and FIG. 5, and then a description of a second example will be given with reference to FIG. 6. As described below, the second example differs from the first example in the point that the sub menu SL is composed of the items each of which indicates commonality between the user A and the user B. It is noted that the first example and the second example can be easily combined by changing the operation method by the user as described below.

### 1. First Example

FIG. 4A shows one example of a screen image which the navigation device 1 outputs at the time when the user selects the content As from the content list CL1 in the first example.

The screen image 20 adopts the touch panel method in which the user can enter the input by pushing. The screen image 20 has the content list display area Ct1 of the content list CL1 which is sent by the first terminal 100 at the left periphery, and has the content list display area Ct2 of the content list CL2 which is sent by the second terminal 200 at the right periphery. The screen image 20 also has the buffer area Bt at the central portion other than the content list display areas Ct1 and Ct2. The content list display areas Ct1 and Ct2 can display all contents in each of the content lists CL1 and CL2 by a vertical scrolling operation. It is noted that the navigation device 1 has already received the attribute information Is related to the contents in the content list CL1 from the first terminal 100, and has already received the attribute information Is related to the contents in the content list CL2 from the second terminal 200. Besides this, the navigation device 1 uses the attribute information Is generated by the attribute information management unit 4 as necessary.

First, the user selects any content which the user wants to copy from the content list CL1 displayed in the content list display area Ct1 (STEP 1). Here, as an example, the navigation device 1 accepts the selection of the content by the drag operation of the two fingers as shown in FIG. 4A.

Then, when the selected content As has transferred to the buffer area Bt by the drag operation of the two fingers, the navigation device 1 displays the sub menu SL composed of the items (relevant menus) each of which indicates relevance to the content As based on the attribute information Is of the content As (STEP 2). Here, the navigation device 1 can display the all items in the sub menu SL by the vertical scrolling operation by the user.

Here, a concrete example of the sub menu SL will be described with reference to FIG. 4B and FIG. 4C.

FIG. 4B shows one example of the sub menu SL displayed at the time when the content As is music, PV (Promotion Video), or other musical content. The sub menu SL in FIG. 4B includes “album”, “artist”, “genre”, and “day of recording”. Besides FIG. 4B, the sub menu SL may include “feeling (melody of content)”, “play list”, “place of reproduction”, “time zones of reproduction”, “season of reproduction”, “traffic situation at the time of reproduction”, “purchased shop”, and “driving route”, for example.

FIG. 4C shows one example of the sub menu SL in a case where the content As is a picture or a video other than PV. The submenu SL in FIG. 4C includes “shooting date”, “shooting location”, “subject person”. Besides FIG. 4C, the sub menu SL may also include “shooter”, “TV record”, “movie”, “comedy”, “model of camera”, “driving route”, “POI (Point of Interface)”, “music included”, for example.

Here, a description will be given of one example of a generating method of the sub menu SL. For example, the navigation device 1 stores a database in the memory which contains items (relevant menus) constituting the sub menus SL each of which corresponds to each piece of the attribute information Is in advance. Then, the navigation device 1 generates the sub menu SL from the attribute information Is of the content As with reference to the database.

Next, a description will be given of the operation which the user executes and a process which the navigation device 1 executes, after the display of the sub menu SL. The user selects any item (selection item Si) from the sub menu SL. For example, the user selects the selection item Si by dragging the finger from the sub menu SL with touching the display portion of the item and pulling the finger off the screen image 20. Then, the navigation device 1 extracts the contents related to the selection item Si from the content list CL1. Concretely, the navigation device 1 searches the content related to the selection item Si by referring to the attribute information Is of each content in the content list CL1. Next, the navigation device 1 displays the content list thus extracted (hereinafter referred to as “relevant content list BL”) on the buffer area Bt. This will be described with reference to FIG. 5.

FIG. 5 shows a display example of the screen image 20 after the selection item Si is determined. As shown in FIG. 5, after the selection item Si is determined, the navigation device 1 extracts the contents related to the content As from content list CL1 based on the selection item Si and displays them as the relevant content list BL on the buffer area Bt (STEP 3). Thereby, the navigation device 1 can present the user with not only the content As but also the contents, which have relevance to the content As the user has designated, on the buffer area Bt. It is noted that the user can select any content in the relevant content list BL by the vertical scrolling operation.

Here, a description will be given of a generating method of the relevant content list BL by using the example shown in FIG. 4B. For example, in a case where the user designates “album” included in the sub menu SL in FIG. 4B as the selection item Si, the navigation device 1 extracts contents included in the album to which the content As belongs from the content list CL1, and displays them in the relevant content list BL. The navigation device 1 executes the above extraction process by referring to the attribute information Is related to each content in the content list CL1. As described above, the attribute information Is related to each content in the content list CL1 is not only automatically generated by the navigation or the first terminal 100 but also generated based on the manual input by the user through the UI units 2 and 102. Similarly, in a case where the user designates the “day of recording” as the selection item Si, the navigation device 1 extracts, for example, contents recorded on the same day or in the same week or in the same month as the content As from the content list CL1, and displays them in the relevant content list BL.

Next, with reference to FIG. 5 again, a description will be given of the operation which the user executes and the process which the navigation device 1 executes. The user selects a content which the user wants to copy from the relevant content list BL and copies the content by dragging it to the content list display area Ct2 (STEP 4). In the example shown in FIG. 5, the user is dragging the content by one finger. Then, the navigation device 1 controls the sending process of the content which is transferred from the relevant content list BL to the content list display area Ct2. One example of this process will be explained in detail in the following section “Content Transmission Example”.

As described above, by displaying the sub menu SL and letting the user determine the selection item Si, the navigation device 1 can present the user with not only the content As but also the relevant content based on the content As and the selection item Si. In this case, since the user can select relevance, the user can execute the copy operation flexibly. Namely, even in a case where the same content is designated, contents which coincide in terms of the different relevance are displayed in the list. As described above, the navigation device 1 can make the copy operation easy and improve the usability when the user wants to copy several contents related to the content As.

### 2. Second Example

In the second example, the navigation device 1 displays mutually-related items between the user A and the user B in the sub menu SL. Thereby, the navigation device 1 makes the copy operation by user more flexible and makes the copy operation easy. This will be described in detail with reference to FIG. 6.

FIG. 6A shows an example of a screen image of the navigation device 1 when the user selects the content As from the content list CL1 in the second example.

First, the user selects any content As which the user wants to copy from the content list CL1 which is shown in the content list display area Ct1 (STEP 1). Here, as an example, the navigation device 1 accepts a selection of the content by the drag operation of the three fingers as shown in FIG. 6A in order to discriminate this operation from the operation of the first example. Thereby, the navigation device 1 can discriminate clearly between the above first example and the second example based on the user operation when processing the operation.

Then, when the selected content As is transferred to the buffer area Bt by the drag operation of the three fingers, the navigation device 1 displays the sub menu SL including items (common relevant menu) which are related to the content As and which have relevance to both the user A and the user B (STEP 2).

Here, a concrete example of the sub menu SL in the second example will be described with reference to FIGS. 6B and 6C.

FIG. 6B shows an example of the sub menu SL displayed in a case where the content As is music, PV, or other musical content. The sub menu SL in FIG. 6B includes “common favorite artist”, “common favorite genre”, and “content we hear when we act together”. The sub menu SL may include common relevant menus such as “relevant information of artist when we hear together”, “other tune when we hear this tune”, “driving route when we hear this tune”, “action history when we hear this tune” besides or instead of the examples in FIG. 6B.

FIG. 6C shows an example of the sub menu SL in a case where the content As is a picture or a video other than PV. The sub menu SL in FIG. 6C includes “content in which we are taken together”, “content when we act together”, “content in which common friend or acquaintance is taken”, and “common hobby content”. The sub menu SL may include various kinds of common relevant menus besides or instead of the examples in FIG. 6C.

Here, an example of a generating method of the sub menu SL will be described below. For example, similarly to the first example, the navigation device 1 stores a database in the memory which contains items (common relevant menus) of the sub menus SL each of which corresponds to each piece of attribute information Is in advance. Then, the navigation device 1 generates the sub menu SL from the attribute information Is related to the content As with reference to the database.

Next, a description will be given of the operation which the user executes and the process which the navigation device 1 executes after the sub menu SL is displayed with reference to FIG. 5 again. After the sub menu SL is displayed, the user selects any item from the sub menu SL. For example, the user selects the selection item Si by keeping touching the display portion of the item and transferring the finger from the sub menu SL and then pulling the finger off the screen image 20.

Then, as shown in FIG. 5, the navigation device 1 extracts relevant contents based on the selection item Si from the content list CL1 similarly to the first example and displays them in the buffer area Bt as the relevant content list BL (STEPS). Thereby, the navigation device 1 can display not only the content As but also contents which have the user-designated relevance to the content As in the buffer area Bt and present them to the user.

Here, a description will be given of an example of the generating method of the relevant content list BL by using the examples of the sub menu SL shown in FIG. 6B and FIG. 6C. For example, when the user selects “common favorite artist” in the sub menu SL in FIG. 6B, the navigation device 1 extracts contents in which common favorite artist of the user A and the user B performs from the content list CL1, and displays them in the relevant content list BL. The navigation device 1 performs the above extraction process by referring to the attribute information Is related to each content in the content list CL1. In this case, the attribute information Is which indicates the common favorite artist of the user A and the user B is generated in advance based on manual input by user through the UI unit 2 or 102 and stored in the navigation device 1 to be related to the content, for example.

Similarly, when the user selects “content in which we are taken together” in the sub menu SL in FIG. 6C, the navigation device 1 extracts contents in which the user A and the user B are taken together from the content list CL1, and displays them in the relevant content list BL. Furthermore, even in a case where the user selects the other items, the navigation device 1 also displays contents considered to be related to the selection item Si in the relevant content list BL.

Thereby, the navigation device 1 can present the user with candidates of the content which the user copies and assigns in consideration of mutual relevance between the user A who provides the content and the user B who is provided with the content. Also, similarly to the first example, since the user can also select the relevance, the navigation device 1 can display a list of common contents in terms of the different relevance even when the same content is designated. Thus, the navigation device 1 can make the user operation easy and improve the flexibility.

(Content Transmission Example)

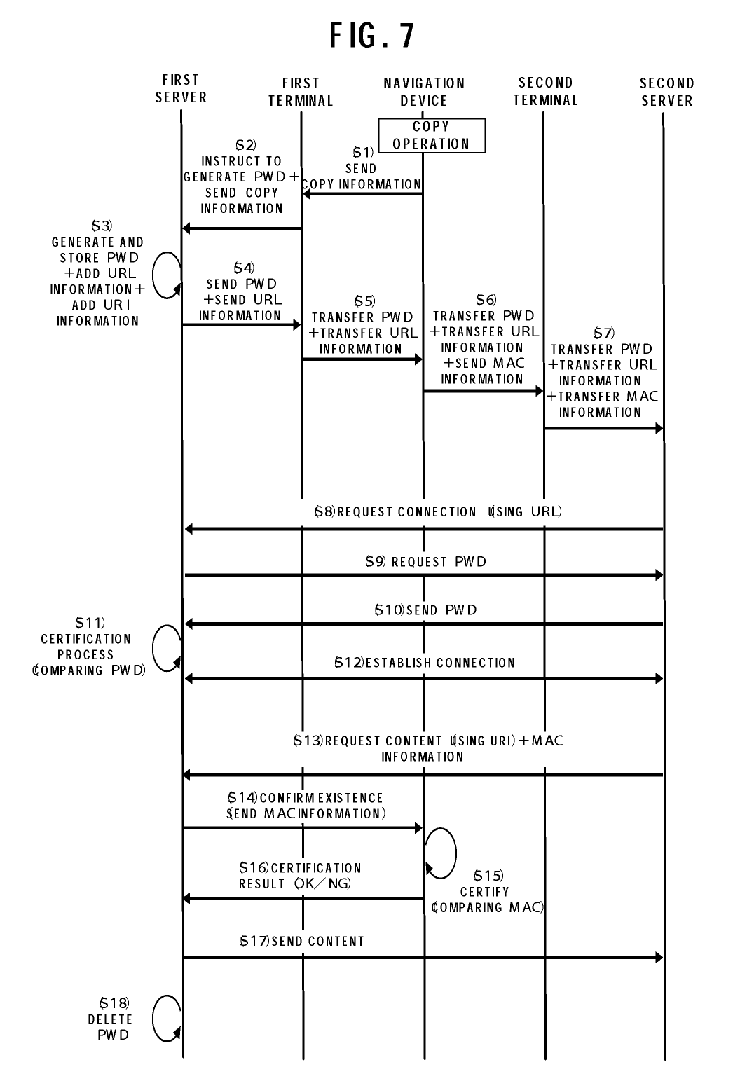

Next, a description will be given of a concrete example of a content transmission process after the content to be copied is designated. FIG. 7 shows one example of a sequence diagram which shows the content transmission process performed after the end of the copy operation. Hereinafter, password is expressed by “PWD”.

First, the navigation device 1 sends the copy information to the first terminal 100 after the end of the copy operation (step Si). Here, the copy information indicates the identification information of the content to be copied and assigned which the user designated, and other information which is related to the content. Then, the first terminal 100 instructs the first server 150 to generate the PWD and sends the copy information (step S2).

Next, the first server 150 generates and stores the PWD, and then adds the URL (Uniform Resource Locator) information which is used at the time of the certification and the URI (Uniform Resource Identifier) information which indicates a location where the content exists (step S3). Here, the PWD is one time password which has a period of validity, for example. Then, the first server 150 sends the PWD to the first terminal 100 and sends the URL information and others (step S4). The first terminal 100 transfers the PWD and the URL information thus received to the navigation device 1 (step S5). Next, the navigation device 1 transfers the received PWD and the URL information to the second terminal 200, and sends its own MAC (Media Access Control) address (hereinafter, referred to as “MAC information”) to the second terminal 200 (step S6). Then, the second terminal 200 transfers the received PWD, the URL information and the MAC information thus received to the second server 250 (step S7).

Next, the second server 250 requests the first server 150 for a connection by using the received URL information (step S8). The first server 150, which has received the connection request, requests the PWD (step S9). Then, the second server 250 sends the PWD to the first server 150 (step S10). The first server 150, which receives the PWD, performs the certification process (step S11). Concretely, the first server 150 determines whether or not the received PWD coincides with the PWD which the first server 150 generates at step S3 by itself. Then, when the certification process is done successfully, the connection between the first server 150 and the second server 250 is established (step S12).

After the connection is established, the second server 250 requests the first server 150 for the content by using the URI and sends the MAC information (step S13). Then, the first server 150, which receives these, sends the MAC information to the navigation device 1 in order to confirm the existence (step S14). The navigation device 1 executes the certification based on the received MAC information (step S15). Concretely, the navigation device 1 determines whether or not the received MAC information and its own MAC address coincide with each other. Then, the navigation device 1 sends the certification result to the first server 150 (step S16). Then, the first server 150 sends the content to the second server 250 if the certification result is affirmative (step S17). Then, the first server 150 discards the PWD which is generated at step S3 after the content transmission is completed (step S18).

Thereby, it can be possible to assure the security and perform the transmission of the content necessarily.

(Process Flow)

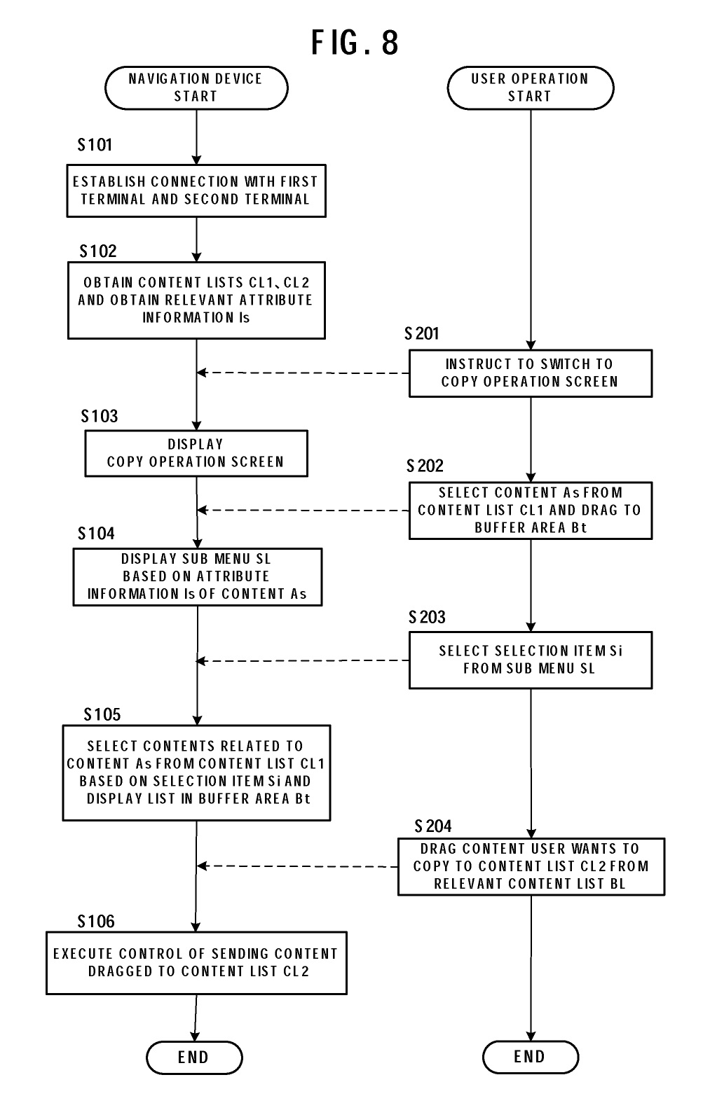

Next, a description will be given of a concrete example of a procedure of the process by the navigation device 1 in the first embodiment. FIG. 8 is one example of a flow chart which shows the procedure of the process by the navigation device 1 in response to the user operation. The flow chart in FIG. 8 is executed when the navigation device 1 exists at a place where the navigation device 1 can communicate with the first terminal 100 and the second terminal 200 by the near field wireless communication unit 5. It is noted that in FIG. 8, the solid arrow shows the flow of the process and the broken arrow shows the input by the operation.

First, the navigation device 1 establishes a connection between the first terminal 100 and the second terminal 200 (step S101). Then the navigation device 1 obtains the content list CL1 and the content list CL2 from the first terminal 100 and the second terminal 200, respectively, and also obtains the attribute information Is related to these contents (step S102). It is noted that the navigation device 1 may generate and store the attribute information Is by the attribute information management unit 4 by itself.

Then, after step S102, the user instructs the navigation device 1 to switch to a screen image for the copy operation at his or her arbitrary timing (step S201). For example, the user instructs the navigation device 1 to switch to the screen image by pushing a predetermined button or pushing the touch panels. Then, the navigation device 1 displays the screen image for the copy operation as shown in FIG. 4A (step S103).

Then, the user determines any content As from the content list CL1 at his or her arbitrary timing, and drags it to the buffer area Bt (step S202). In response, the navigation device 1 displays the sub menu SL based on the attribute information Is of the content As (step S104).

Next, the user determines any selection item Si from the sub menu SL displayed (step S203). In this case, the navigation device 1 extracts contents related to the content As based on the selection item Si from the content list CL1, and displays their list in the buffer area Bt (step S105). In other words, thereby the relevant content list BL is displayed in the buffer area Bt.

Next, the user drags the content which the user wants to copy from the relevant content list BL to the content list CL2 (step S204). Here, the contents in the relevant content list BL are extracted based on the selection item Si which the user designates. Therefore, the user can easily execute the copy operation of several relevant contents.

In response, the navigation device 1 executes a control of sending the content which is dragged to the content list CL2 (step S106). Concretely, in accordance with the sequence diagram in FIG. 7, the content which is designated at step S204 is sent from the first server 150 to the second server 250.

As mentioned above, the navigation device in this embodiment includes a receiving unit, a content list display unit, a first input accepting unit, a sub menu display unit, a second input accepting unit, and a relevant content extracting unit. The receiving unit receives the content list which includes identification names of contents from the first terminal. The content list display unit displays the content list. The first input accepting unit accepts a user input for designating any content in the content list by a touch panel or others. The sub menu display unit displays a sub menu composed of items designating relevance to designated contents, on the basis of attribute information of a designated content which is designated from the content list by user input. The second input accepting unit accepts a designation of the item in the sub menu by the user input. The relevant content extracting unit extracts contents related to the designated content from the content list on the basis of the designated item. In other words, the relevant content extracting unit extracts contents which have relevance to the designated content in terms of the designated item. After then, the copy supporting device lets the user designate a content to be copied from the extracted contents. In this way, by displaying the sub menu and letting the user designate the item, the copy supporting device can properly extract relevant contents based on the relevance which the user designated. Thus, it becomes possible to make the copy operation by user easy and improve the usability.

(First Modification)

In the system configuration of the first embodiment, the navigation device 1 has the wide area wireless communication unit 7 and is configured to be able to communicate with the first server 150 and the second server 250 via the communication network 300. Instead of this, the navigation device 1 does not have to include the wide area wireless communication unit 7.

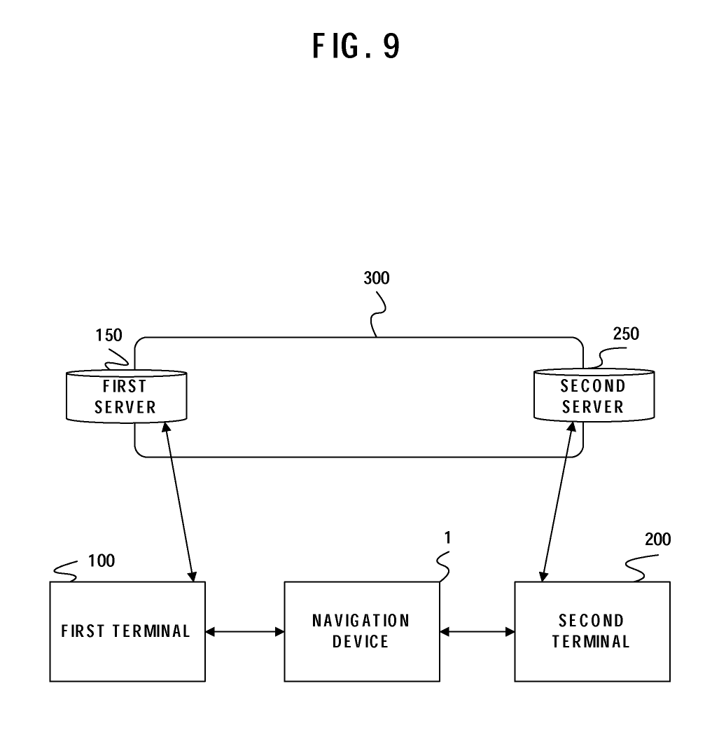

This will be described below with reference to FIG. 9. FIG. 9 shows one example of a schematic configuration of the content copy system in the first modification. As shown in FIG. 9, the navigation device 1 can communicate at close range only with the first terminal 100 and the second terminal 200. In this case, the navigation device 1 sends or receives the content lists CL1 and CL2 and the attribute information Is to or from the first terminal 100 and the second terminal 200 as necessary. Also, at the time of transmitting the content, similarly to the above section “Content Transmission Example”, the navigation device 1 sends the copy information to the first terminal 100, and transfers information such as the PWD transferred by the first terminal 100 to the second terminal 200. Thus, the present invention can be preferably applied to the first modification, too.

(Second Modification)

In the first embodiment, the first terminal 100 and the first server 150, and also the second terminal 200 and the second server 250 are the separated devices, respectively. But, a configuration to which the present invention can be applied is not limited to this configuration. Instead of this, the first terminal 100 and the first server 150, and the second terminal 200 and the second server 250 may be integrated, respectively.

For example, if the first server 150 is integrated into the first terminal 100, the first terminal 100 stores contents which the user A possesses in the memory. Similarly, if the second server 250 is integrated into the second terminal 200 for example, the second terminal 200 stores contents which the user B possesses in the memory. Also, in either case, the navigation device 1 copies the content according to the flow chart in FIG. 8, for example. Hence, the present invention can be preferably implemented by the second modification.

(Third Modification)

Instead of the configuration in the first embodiment, the navigation device 1 may store the contents which the user A and/or the user B possess in its own memory. In other words, the navigation device 1 may have the functions of the first server 150 and/or the second server 250.

For example, in a case where the contents of the user A are stored in the memory of the navigation device 1, the navigation device 1 picks up the designated content from the memory and sends it to the second server 250 after the copy operation. In another example, in a case where the contents of the user B are stored in the memory of the navigation device 1, the navigation device 1 receives the designated content from the first server 150 after the copy operation. In yet another example, in a case where contents of the user A and the user B are stored in the memory of the navigation device 1, after the copy operation, the navigation device 1 changes the attribute of the designated content so that the content is available for the user B. As mentioned above, the present invention can be preferably implemented by the third modification.

(Fourth Modification)

In the first embodiment, as an example of the process for the copy operation, the first example and the second example are illustrated on the basis of whether or not mutual relevance between the user A and the user B is considered. However, a method which can be applied to the present invention is not limited to the method. For example, instead of this or besides this, the navigation device 1 may display the sub menu SL which is related to the first attribute Is1 or the sub menu SL which is related to the second attribute Is2 on the basis of the user operation.

In this case, for example, when the user drags the content As to the buffer area Bt on the screen image 20 in FIG. 4A by the two fingers, the navigation device 1 displays the sub menu SL related to the first attribute Is1 of the content As. In another example, when the user drags the content As to the buffer area Bt on the screen image 20 in FIG. 4A by the three fingers, the navigation device 1 displays the sub menu SL related to the second attribute Is2 of the content As. As mentioned above, the present invention can be also preferably implemented by the fourth modification.

(Fifth Modification)

In the above first example and the second example, the navigation device 1 displays the relevant content list BL in the buffer area Bt and lets the user select the content which the user wants to copy. However, the method to which the present invention can be applied is not limited to this method.

Instead of this, for example, the navigation device 1 may display an icon for selecting the batch copy of the contents in the relevant content list BL on the screen image 20, and copy all contents in the relevant content list BL when the user pushes the icon. In another example, the navigation device 1 may automatically execute the control of copying contents in the relevant content list BL after generating the relevant content list BL based on the selection item which the user has determined.

(Sixth Modification)

The content copy system in the first embodiment has the navigation device 1 as its own component. Instead of this, the content copy system may have a display device and an input device, and also have other device (copy supporting device) which can communicate with the first terminal 100 and the second terminal 200 as its own components. Namely, in this case, the user executes the copy operation based on the screen image which the copy supporting device displays. Thereby, the present invention can be also preferably applied.

### Second Embodiment

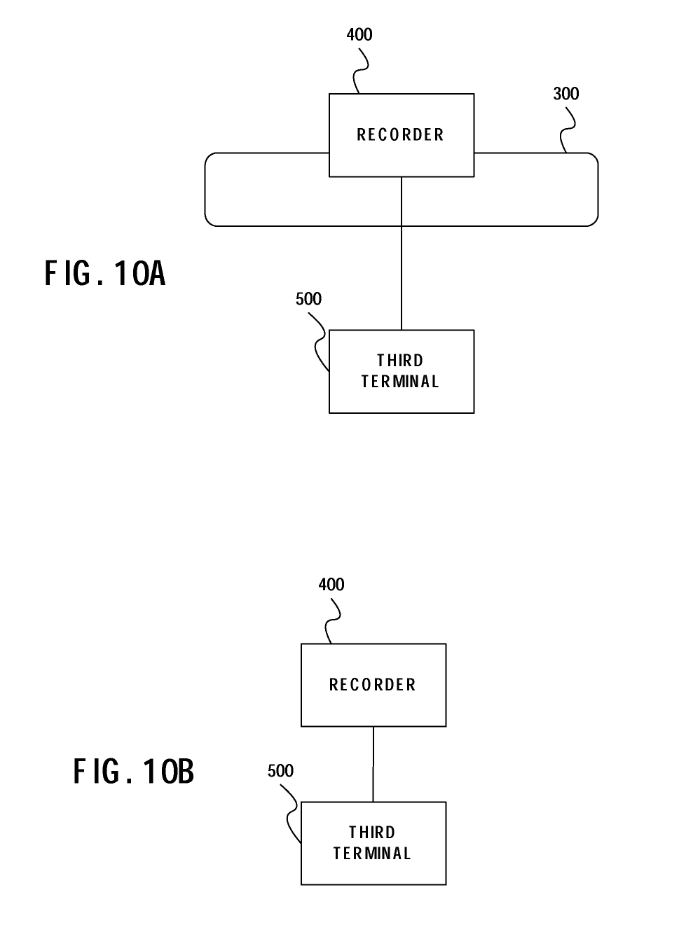

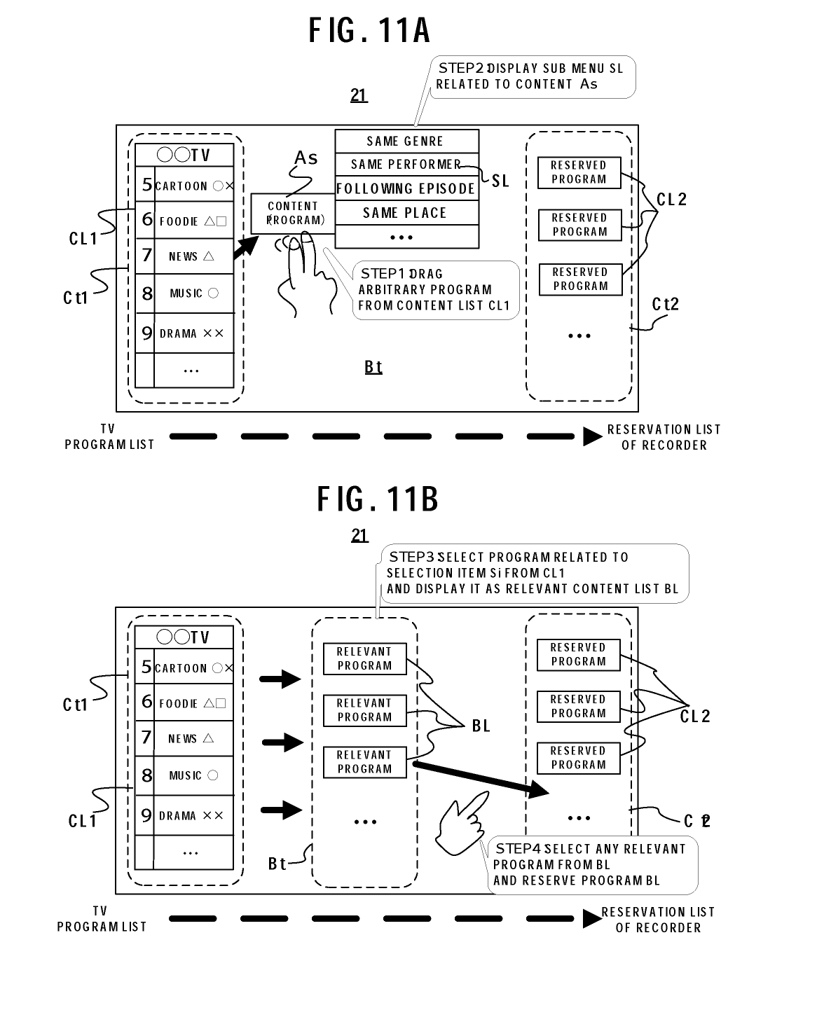

In the second embodiment, a reservation for television programs from a terminal to a recorder in a house is performed. The present invention can also be applied to such a case. This description will be given with reference to FIG. 10 and FIG. 11.

FIGS. 10A and 10B show examples of configurations of a program reservation system in the second embodiment. FIG. 10A shows a case where the third terminal 500 and the recorder 400 communicate via the communication network 300, and FIG. 10B shows a case where the third terminal 500 and the recorder 400 execute a wireless communication at close range directly.

The third terminal 500 receives an electric program guide (EPG) by receiving the radio wave or by communicating via the communication network 300. In FIGS. 10A and 10B, the third terminal 500 sends the recorder 400 a signal (a recording instruction signal) which instructs to record a reserved program which the user designates via the communication network 300 or by the wireless communication at close range.

The recorder 400 receives the recording instruction signal sent from the third terminal 500 via the communication network 300 or by the wireless communication at close range, and records a program which is designated on the basis of the recording instruction signal.

Next, a description will be given of the process of the program reservation in the second embodiment with reference to FIGS. 11A and 11B. FIG. 11A shows the screen image 21 which the third terminal 500 outputs at the time of the program reservation in the second embodiment.

As shown in FIG. 11A, in the content list display area Ct1 at the left side of the screen image 21, the content list CL1 (i.e., program list) including a number of programs is displayed. Also, in the content list display area Ct2 at the right side of the screen image 21, the content list CL2 (i.e., reservation list) including the reserved programs the user has already designated is displayed. Here, as an example, the content list CL1 has two-dimensional array in which the programs in the same horizontal row is broadcasted in the same time zone and the programs in the same vertical column is broadcasted by the same broadcast station. Besides, the content list display area Ct1 can display any content in the content list CL1 by the vertical and horizontal scrolling operation.

First, the user drags any program which the user wants to reserve from the content list CL1 to the buffer area Bt (STEP 1). Here, as an example, the navigation device 1 accepts a selection of the program by the drag operation of the two fingers as shown in FIG. 11A.

Then, when the selected program (content As) is transferred to the buffer area Bt by the drag operation of the two fingers, the third terminal 500 displays the sub menu SL which includes the item designating the relevance to the content As (STEP 2). In this case, the attribute information Is includes not only program information added to the EPG but also information which the third terminal 500 obtains via the Internet. In FIG. 11A, the sub menu includes “same genre”, “same performer”, “following episode”, and “same place”. Thereby, the third terminal 500 lets the user select any item in the sub menu SL. Here, the terms “following episode” means sequels to the same or common program (television drama), and the terms “same place” means the area where the shooting location or the interview location is in common.

Here, a description will be given of a generating method of the sub menu SL. For example, the third terminal 500 stores a database containing the items of the sub menus SL each of which corresponds to each piece of the attribute information Is in its own memory in advance. Then, the third terminal 500 generates the sub menu SL with reference to the database by using the attribute information Is related to the content As.

Then, the user selects any item from the sub menu SL. For example, the user selects the selection item Si by dragging the finger from the sub menu SL with touching the display portion of the item and then lifting the finger off the screen image 21. Thereby, the third terminal 500 can extract programs related to the selection item Si from the content list CL1 and present them to the user. This concrete description will be given with reference to FIG. 11B.

FIG. 11B shows a display example of the screen image 21 after the selection item Si is determined. As shown in FIG. 11B, after determining the selection item Si, the third terminal 500 extracts contents (relevant programs) related to the selection item Si from the content list CL1 and displays them in the buffer area Bt as the relevant content list BL (STEPS). Thereby, the third terminal 500 can display not only the content As but also the contents (relevant programs) which have a user-designated relevance to the content As in the buffer area Bt.

For example, in a case where the user selects “same genre” in the sub menu SL, the third terminal 500 displays programs which have the same genre as the genre (news or variety show) of the content As in the relevant content list BL. Similarly, in a case where the user selects “same performer”, the third terminal 500 displays the programs, whose performers appears in the content As, in the relevant content list BL.

Then, the user reserves the program by selecting the relevant program which the user wants to reserve from the relevant content list BL and dragging it in the content list display area Ct2 (STEP 4). Thereby, the relevant program dragged is added to the content list CL2 (i.e., reservation list).

After that, the third terminal 500 sends the recorder 400 the recording instruction signal of the reserved programs which constitute the content list CL2. Then, the recorder 400 records the programs on the basis of the received recording instruction direction signal.

In this way, by displaying the sub menu SL and then letting the user select the selection item Si, and extracting and displaying programs which have relevance to the selection item Si, the third terminal 500 can simplify the complex operation of the program reservation. It is noted that the above relevance is selected by the user. Thus, the third terminal 500 can precisely present the programs which the user intends in the relevant content list BL and can simplify the operation of the program reservation.

(Modification)

The above first to fifth modifications in the first embodiment can be applied to the second embodiment as well. In this case, after extracting the relevant content list BL, the third terminal 500 sends the recorder 400 the recording instruction signal of all programs in the relevant content list BL.

### BRIEF DESCRIPTION OF THE REFERENCE NUMBER

1 Navigation Device
100 First Terminal
150 First Server
200 Second Terminal
250 Second Server
300 Communication Network
400 Recorder
500 Third Terminal

1. A copy supporting device which communicates with a first terminal used by a user who provides contents, comprising:
a receiving unit which receives a content list of the contents which the user possesses from the first terminal;
a content list display unit which displays the content list;
a first input accepting unit which accepts an external input for designating any content in the content list;
a sub menu display unit which displays, based on attribute information of a designated content designated from the content list by the external input, a sub menu which includes items designating relevance to the designated content;
a second input accepting unit which accepts a designation of the item by an external input; and
a relevant content extracting unit which extracts contents related to the designated content from the content list based on the designated item.

2. The copy supporting device according to claim 1, further comprising:
a relevant content list display unit which displays a relevant content list which is a list of contents extracted by the relevant content extracting unit; and
a copy control executing unit which executes a control of copying a content designated from the relevant content list based on an external input.

3. The copy supporting device according to claim 2,
which communicates with a second terminal used by a user who is provided with the content,
wherein the receiving unit receives a content list of the second terminal, and
wherein the content list display unit displays the content list of the second terminal, and
wherein the copy control executing unit executes the control of copying a content which is transferred from the relevant content list to the content list of the second terminal based on an external input.

4. The copy supporting device according to claim 1,
wherein the attribute information includes a first attribute which the content originally has and a second attribute which is generated due to a user action.

5. The copy supporting device according to claim 3,
wherein the sub menu display unit displays the sub menu including items each of which indicates commonality between the user of the first terminal and the user of the second terminal based on the attribute information of the designated content.

6. A terminal device which sends a recording instruction signal to a program recording device which records designated programs, comprising:
a program information obtaining unit which obtains program information including identification names of programs and attribute information of the programs by an electromagnetic method;
a program list display unit which displays a list of programs based on the program information;
a first input accepting unit which accepts an external input for designating any program in the list;
a sub menu display unit which displays a sub menu including items which designates relevance to the designated program based on the attribute information of the designated program which is designated from the list by the external input;
a second input accepting unit which accepts a designation of the item by an external input; and
a relevant program extracting unit which extracts programs related to the designated program from the list based on the designated item.

7. The terminal device according to claim 6, further comprising:
a relevant program list display unit which displays a relevant program list which is a list of the programs extracted by the relevant program extracting unit; and
a program reservation notifying unit which sends the recording instruction signal of the program designated from the relevant program list based on an external input.

8. A copy supporting method which is executed by a copy supporting device which communicates with a first terminal used by a user who provides contents, comprising:
a receiving process which receives a content list of the contents which the user possesses from the first terminal;
a content list display process which displays the content list;
a first input accepting process which accepts an external input for designating any content in the content list;
a sub menu display process which displays, based on attribute information of a designated content designated from the content list by the external input, a sub menu which includes items designating relevance to the designated content;
a second input accepting process which accepts a designation of the item by an external input; and
a relevant content extracting process which extracts contents related to the designated content from the content list based on the designated item.

9. A copy supporting program stored on a non-transitory storage medium and executed by a computer which communicates with a first terminal used by a user who provides contents, making the computer function as:
a receiving unit which receives a content list of the contents which the user possesses from the first terminal;
a content list display unit which displays the content list;
a first input accepting unit which accepts an external input for designating any content in the content list;
a sub menu display unit which displays, based on attribute information of a designated content designated from the content list by the external input, a sub menu which includes items designating relevance to the designated content;
a second input accepting unit which accepts a designation of the item by an external input; and
a relevant content extracting unit which extracts contents related to the designated content from the content list based on the designated item.

10. (canceled)

11. The copy supporting device according to claim 2,
wherein the attribute information includes a first attribute which the content originally has and a second attribute which is generated due to a user action.

12. The copy supporting device according to claim 3,
wherein the attribute information includes a first attribute which the content originally has and a second attribute which is generated due to a user action.

13. The copy supporting device according to claim 4,
wherein the sub menu display unit displays the sub menu including items each of which indicates commonality between the user of the first terminal and the user of the second terminal based on the attribute information of the designated content.

14. The copy supporting device according to claim 11,
wherein the sub menu display unit displays the sub menu including items each of which indicates commonality between the user of the first terminal and the user of the second terminal based on the attribute information of the designated content.

15. The copy supporting device according to claim 12,
wherein the sub menu display unit displays the sub menu including items each of which indicates commonality between the user of the first terminal and the user of the second terminal based on the attribute information of the designated content.
